(19) United States
(12) Patent Application Publication
(10) Pub. No.: US 2017/0308648 A1
(43) Pub. Date: Oct. 26, 2017

(54) PATIENT STATUS UPDATE AND THIRD PARTY ENGAGEMENT SYSTEM

(71) Applicant: Loop Med, Inc., Petaluma, CA (US)

(72) Inventors: Crispin C. A. Clarke, Petaluma, CA (US); Shannon M. Griffin, San Francisco, CA (US)

(21) Appl. No.: 15/134,339

(22) Filed: Apr. 20, 2016

(51) Int. Cl. G06F 19/00

(52) U.S. Cl. CPC G06F 19/322; G06F 19/327; G06F 19/328

(57) ABSTRACT

A healthcare communication system for providing status updates of patients is provided. The system receives information about a patient who will undergo a medical procedure at a healthcare facility and information about family and friends of the patient. The patient invites the family and friends to receive status updates about the patient and the medical procedure. Healthcare providers use a patient tracking board user interface to indicate a change in a stage of the patient through the medical procedure. The system generates status updates based on the changes in stages of the patient and provides the status updates, as well as opportunities to offer support, to the family and friends. For instance, the system generates a patient progress bar user interface, secure group messaging, gift giving, and a clinical news feed interface including the status updates for presentation on client devices of the family and friends.

### BACKGROUND

This disclosure relates generally to the fields of healthcare and information technology, and specifically to providing status updates of, and engaging third party support for, a patient through stages of a medical procedure.

A healthcare facility has access to large amounts of information describing patients undergoing medical procedures at the healthcare facility, e.g., a hospital. Family, friends, and others associated with a patient undergoing treatment at the healthcare facility are likely to be interested in learning about the status of the patient, for example, the status of a surgery, whether the surgery was successful, and when the patient can be picked up. Family and friends can have satisfying ways to show their support with peace of mind knowing that the patient is in good condition. If the patient is in need of assistance, then family and friends will likely want to provide assistance to the patient, e.g., run an errand to find a particular medication or food.

Currently, it is difficult for healthcare facilities to share a patient's electronic protected health information (EPHI) with individuals associated with the patient and subsequently to allow these individuals to actively interface with this information. Furthermore, family and friends typically must wait to receive phone calls from healthcare providers or visit the patient in-person at the healthcare facility to receive updates regarding the patient's status directly from a healthcare provider, e.g., a nurse or doctor. Often, a single family member or friend assumes the role of a primary point of contact for the patient. The primary point of contact may be burdened by numerous requests from other family and friends for information about the patient.

Information regarding the patient's status may often be manually written down by the healthcare provider on a paper file at the healthcare facility, which requires additional time for healthcare providers to search for the file and then provide it only to a limited number of the patient's family and friends. Information regarding the patient's status may also be recorded electronically. However, it still requires time for healthcare providers to search for the electronic record (e.g., searching a database using a computer) and provide it to family and friends. Having to be physically on-site at a healthcare facility waiting for nurses and doctors to be available to provide a status of the patient results in a poor user experience for family and friends. Additionally, it is not possible to communicate with all family and friends at once (including those who are not at the hospital), and there is no way for family and friends outside of the healthcare facility to communicate as a group with the patient immediately after the medical procedure. Further, multiple healthcare providers may be involved providing medical care for the patient. In the often hectic bustle of modern society, it is impractical for the family and friends to rely on the current methods to receive information from healthcare providers about the patient's status.

### SUMMARY

A healthcare communication system for providing status updates of patients and engaging third parties is provided. The healthcare communication system receives registration information about a patient who will undergo a medical procedure at a healthcare facility. Before the day of the medical procedure, the healthcare communication system allows the patient to self-register using a user interface for the system. The healthcare communication system also receives information indicating users associated with the patient, e.g., family and friends of the patient, whom the patient is inviting to receive status updates about the patient and the medical procedure. Accordingly, the healthcare communication system provides an invitation to the family and friends, e.g., as an email or text message to mobile phone client devices of the family and friends. The healthcare communication system provides a patient tracking board user interface on a computer or mobile client device to healthcare providers treating the patient. The healthcare providers use the patient tracking board user interface to indicate a change in a stage of the patient through the medical procedure. For example, the patient progresses through the following stages: pending, check-in, pre-op, in surgery, recovery, admission, discharge, and home. The healthcare communication system generates status updates based on the changes in stages of the patient and provides the status updates to the family and friends. For instance, the healthcare communication system generates a patient progress bar user interface, secure group messaging, gift giving, and/or a clinical news feed interface including the status updates for presentation on the client devices of the family and friends. The healthcare communication system supports technical safeguards, administrative safeguards, and physical safeguards to comply with rules of the Health Insurance Portability and Accountability Act (HIPAA). By protecting health information, e.g., securely sharing sensitive information of a patient only with explicit consent granted by the patient, the healthcare communication system is HIPAA compliant.

Accordingly, the provided healthcare communication system provides a technical solution to a problem rooted in technology. In particular, the problem is that electronic healthcare records, e.g., information about the status of a patient undergoing a medical procedure at a healthcare facility, are difficult to organize and distribute to target recipients. Family and friends of the patient cannot easily access information about the status of the patient. For instance, the information is secured such that only healthcare providers at the healthcare facility can access it by providing sufficient credentials. In the busy environment of a healthcare facility, it is not practical for healthcare providers such as doctors and nurses to always have time to search for information about the status of the patient (e.g., searching through a spreadsheet or electronic file folders on a computer) and provide the information expediently to all of the family and friends of the patient who are interested in staying informed and engaged. For instance, the family and friends call the healthcare providers to request the information, but the healthcare providers are too busy to respond to the request in a timely manner. As a result, the family and friends may be anxiously waiting for long periods of time before knowing whether the patient's medical procedure was successful or if the patient has been discharged and can be picked up to bring home. Additionally, this process is a pain point for the healthcare providers who often need to repeat the same information to each of multiple friends and family members who request the patient's status updates. Due to time constraints, the healthcare providers frequently try to tightly limit the number of family and friends to whom they can be responsible to contact with occasional updates. For sentimental, cultural, and/or religious reasons, the family and friends of patients often wish to know when, for example, the patient goes into surgery so that they can focus their thoughts and prayers in support simultaneously. With easy access to consistent and accurate information, families and friends can better coordinate amongst themselves to arrange for visiting, gift giving, pick-up, and care for the patient.

The healthcare communication system provides a technical solution by providing user interfaces on client devices for the family and friends of the patient and the healthcare providers treating the patient. The user interface for healthcare providers, a color-coded patient tracking board user interface, presents information about all patients at a healthcare facility undergoing medical procedures and enables the healthcare providers to easily change a status of a patient. The healthcare communication system synchronizes the patient tracking board with the user interfaces for family and friends, for example, a patient progress bar, secure group messaging, or a clinical news feed user interface displayed on mobile client devices of the family and friends. Thus, the family and friends (including those who are not at the healthcare facility) receive prompt status updates about the patient, for example, at what time the patient has completed a medical procedure so that the family and friends can schedule a visit to the patient at the healthcare facility. Family and friends (including those outside the healthcare facility) can also interact with and support the patient as a group via their client devices immediately after the medical procedure.

### BRIEF DESCRIPTION OF THE DRAWINGS

FIG. 1 is a block diagram of a system environment for providing status updates of patients according to one embodiment.

FIG. 2 is a block diagram of the system architecture of a healthcare communication system within the environment of FIG. 1 according to one embodiment.

FIG. 3A shows a user interface of a registration process of the healthcare communication system according to one embodiment.

FIG. 3B shows a user interface of an invitation process of the healthcare communication system according to one embodiment.

FIG. 4 shows a patient tracking board of the healthcare communication system according to one embodiment.

FIG. 5A shows a patient progress bar of the healthcare communication system according to one embodiment.

FIG. 5B shows an intra-surgery status bar of the healthcare communication system according to one embodiment.

FIG. 6A shows a clinical news feed user interface of the healthcare communication system according to one embodiment.

FIG. 6B shows a group messaging user interface of the healthcare communication system according to one embodiment.

FIG. 6C shows a healthcare social network user interface of the healthcare communication system according to one embodiment.

FIG. 7 shows a healthcare provider metrics user interface of the healthcare communication system according to one embodiment.

FIG. 8 is a data flow diagram of the healthcare communication system according to one embodiment.

FIG. 9 is a flowchart of a process of providing status updates of patients according to one embodiment.

### DETAILED DESCRIPTION

### System Overview

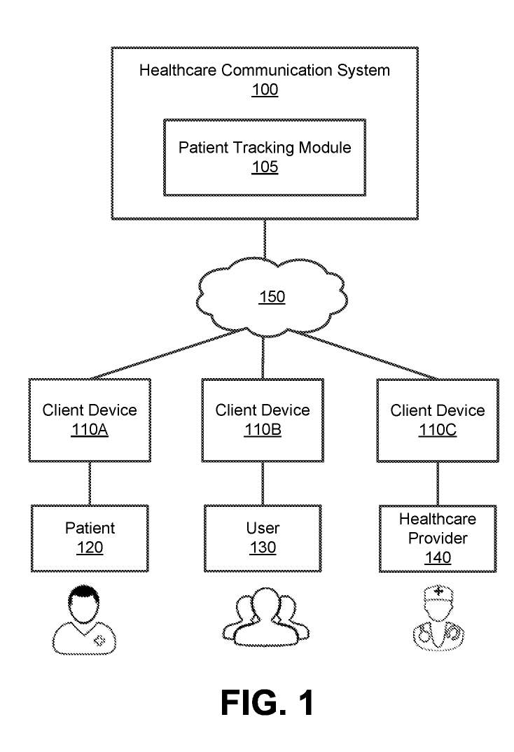

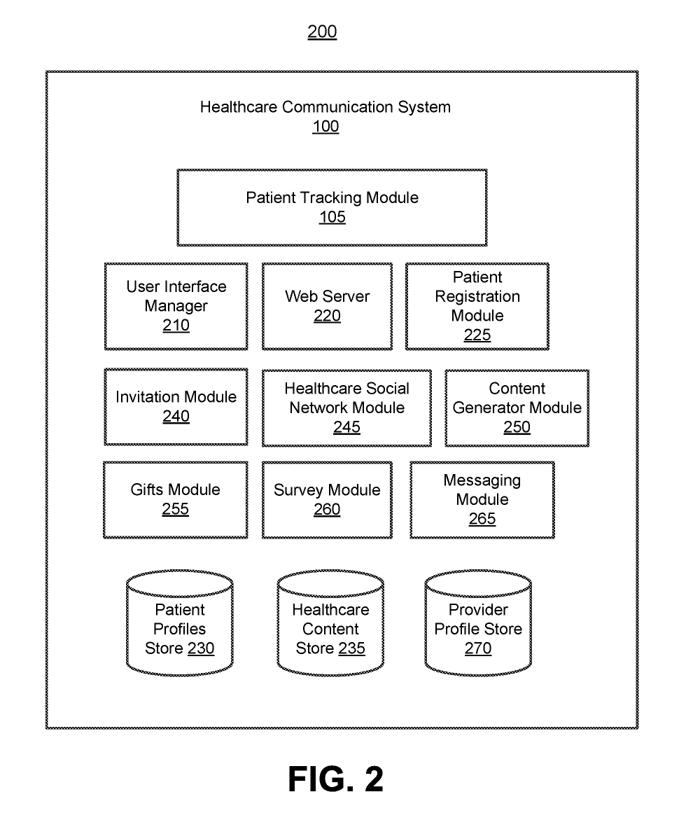

FIG. 1 is a block diagram of a system environment for providing status updates of patients according to one embodiment. The healthcare communication system 100 includes a patient tracking module 105, among other modules further described in FIG. 2. A patient 120 undergoing a medical procedure at a healthcare facility interacts with the healthcare communication system 100 via a user interface of a first client device 110A connected to the system 100 through the network 150. A user 130 associated with the patient interacts with the healthcare communication system 100 via a user interface of a second client device 110B connected to the system 100 through the network 150. A healthcare provider 140 of the health care facility interacts with the healthcare communication system 100 via a user interface of a third client device 110C connected to the system 100 through the network 150. Some embodiments of the system 100 may have additional, fewer, and/or different modules than the ones described herein and have more than three client devices (i.e., client devices 110A, 100B, and 100C), patients 120, users 130, and healthcare providers 140. The functions can be distributed among the modules in a different manner than described in FIG. 1.

A client device (e.g., 110A, 110B, and 100C) is an electronic device used by a user (e.g., patient 120, user 130, and healthcare provider 140) to perform functions such as executing software applications, consuming digital content, browsing websites hosted by web servers on the network 150, downloading files, and the like. For example, the client device may be a mobile device, a tablet, a notebook, a smartwatch, a desktop computer, or a portable computer. The client device includes interfaces with a display device on which the user may view webpages, videos and other content. In addition, the client device provides a user interface (UI), such as physical and/or on-screen buttons with which the user may interact with the client device to perform functions such as viewing, selecting, and consuming digital content such as digital medical records, webpages, photos, videos and other content.

The network 150 enables communications among network entities such as the client devices (e.g., 110A, 110B, and 100C) and the healthcare communication system 100. In one embodiment, the network 150 comprises the Internet and uses standard communications technologies and/or protocols, e.g., BLUETOOTH®, WiFi, ZIGBEE®, clouding computing, other air to air, wire to air networks, and mesh network protocols to client devices, gateways, and access points. In another embodiment, the network entities can use custom and/or dedicated data communications technologies. For example, the network 150 allows the client devices (e.g., 110A, 110B, and 100C) to download an application of the healthcare communication system 100 from a third party service such as Apple® App store and Google® Play.

In one embodiment, the healthcare communication system 100 receives information about the patient from the first client device 110A, including information about the user 130 associated with the patient. The healthcare communication system 100 also receives information about a status of the patient from the third client device 110C from a healthcare provider. The patient tracking module 105 generates status updates indicating a current stage of the patient in the medical procedure and provides the status updates to the second client device 110B for presentation to the user 130 and/or to the third client device 100C for presentation to the healthcare provider 140.

FIG. 2 is a block diagram of the system architecture 200 of the healthcare communication system 100 within the environment of FIG. 1 according to one embodiment. The healthcare communication system 100 in FIG. 2 includes a patient tracking module 105, user interface manager 210, web server 220, patient registration module 225, patient profiles store 230, healthcare content store 235, invitation module 240, healthcare social network module 245, content generator module 250, gifts module 255, survey module 260, messaging module 265, and provider profile store 270. In other embodiments, the healthcare communication system 100 may include additional, fewer, and/or different modules for various applications. Conventional components such as network interfaces, security mechanisms, load balancers, failover servers, management and network operations consoles, and the like are not shown so as to not obscure the details of the system 100. Also, it is noted that the modules may be embodied as hardware, software (which may include firmware), or any combination thereof. For software, it may include program code or code segments, e.g., for a native application on a mobile client device. Software is comprised of one or more instructions storable in a computer readable storage medium, e.g., a memory or disk, and executable by a processor.

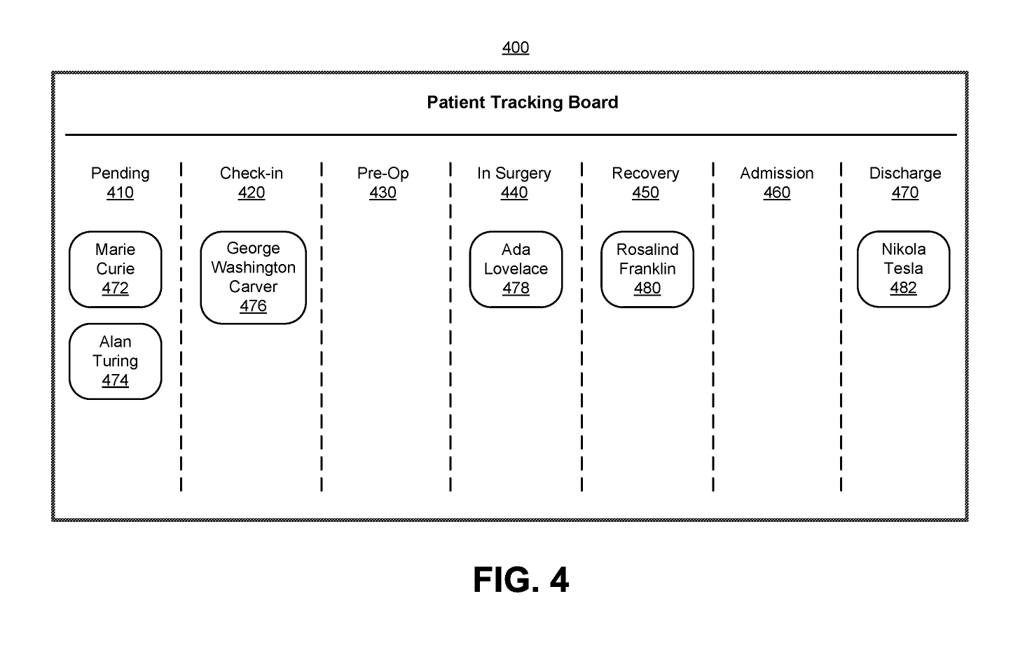

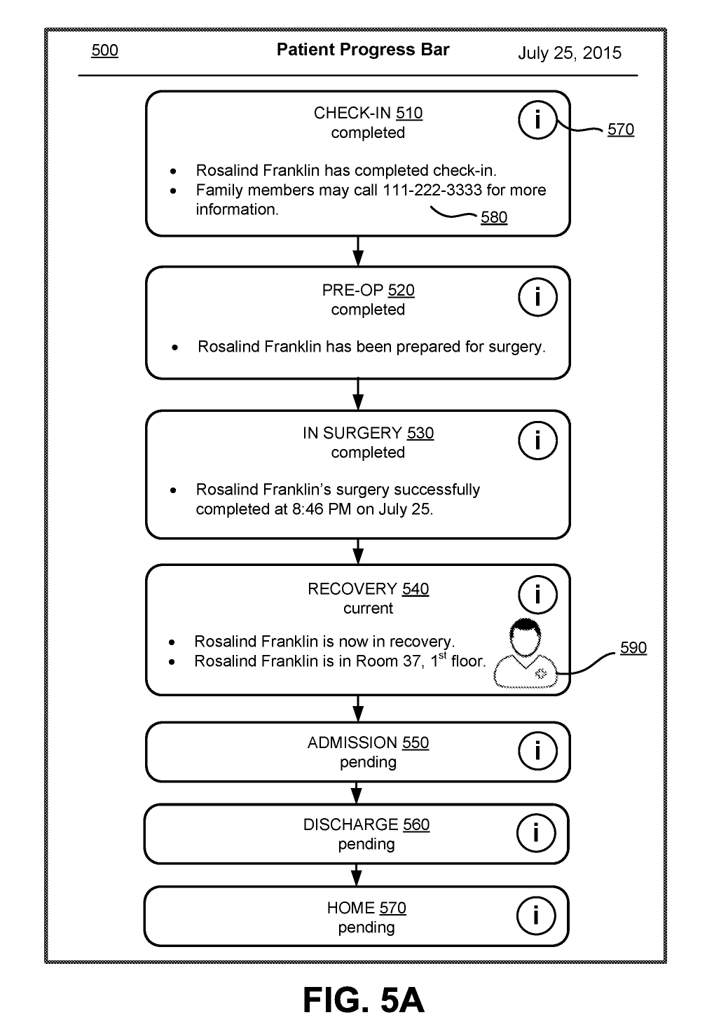

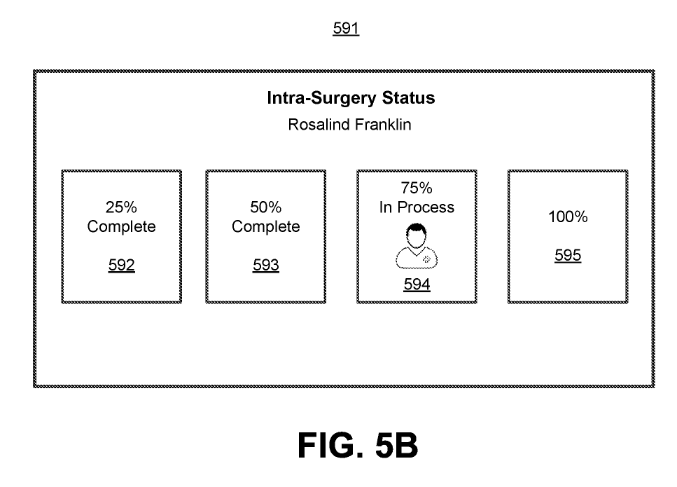

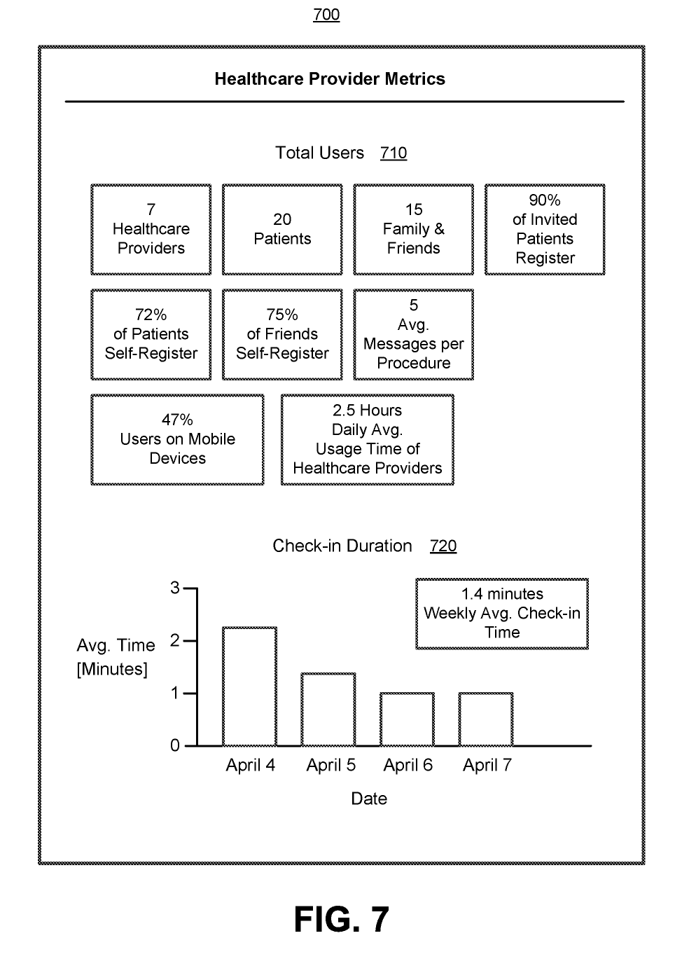

The patient tracking module 105 may be configured to receive information about patients 120 and medical procedures of patients. The information may be input by healthcare providers 140 and/or appropriate staff at a healthcare facility. Based on the information, the patient tracking module 105 generates status updates, e.g., indicating the status and relevant details of a patient undergoing a medical procedure and indicating a current stage of the patient in the medical procedure, for presentation in a graphical user interface. For instance, the patient tracking module 105 receives input from the patient 120 via the client device 110A, from the user 130 associated with the patient via the client device 110B, from the healthcare provider 140 via the client device 110C, and/or from another sources such as a database store of the system 100. Based on the received input, the patient tracking module 105 generates graphical user interfaces, e.g., the patient tracking board further described in FIG. 4, the patient progress bar further described in FIG. 5A, the intra-surgery status bar further described in FIG. 5B, and the healthcare provider metrics further described in FIG. 7. The patient tracking module 105 provides the graphical user interfaces to the client devices (client device 110A, 110B, and/or 110C) for display to a viewer (the patient 120, the user 130, and/or the healthcare provider 140) via the user interface manager 210. The patient tracking module 105 encrypts information associated with the graphical user interfaces to serve as a technical safeguard for HIPAA compliance.

The user interface manager 210 may be configured to allow viewers of the healthcare communication system 100 (e.g., the patient 120, the user 130, and the healthcare provider 140) to view and/or interact with graphical user interfaces generated by the system 100 by communicating information between the system 100 and the client devices (i.e., client devices 100A, 110B, and 110C).

The web server 220 may be configured to link the healthcare communication system 100 via the network 150 to client devices (e.g., client devices 110A, 110B, and 110C). In an embodiment, the web server 220 serves web pages, as well as other web-related content, such as Flash, XML, and so forth. The web server 220 provides the functionality of receiving and routing messages and/or information, e.g., between the healthcare communication system 100 and the client devices 110A, 110B, and 110C, as well as other external systems. These messages can be instant messages, queued messages (e.g., email), text and SMS (short message service) messages, images (e.g., photographs, symbols, or diagrams), push notifications (badges, banners, sounds, or custom text alerts), or any other suitable messaging technique.

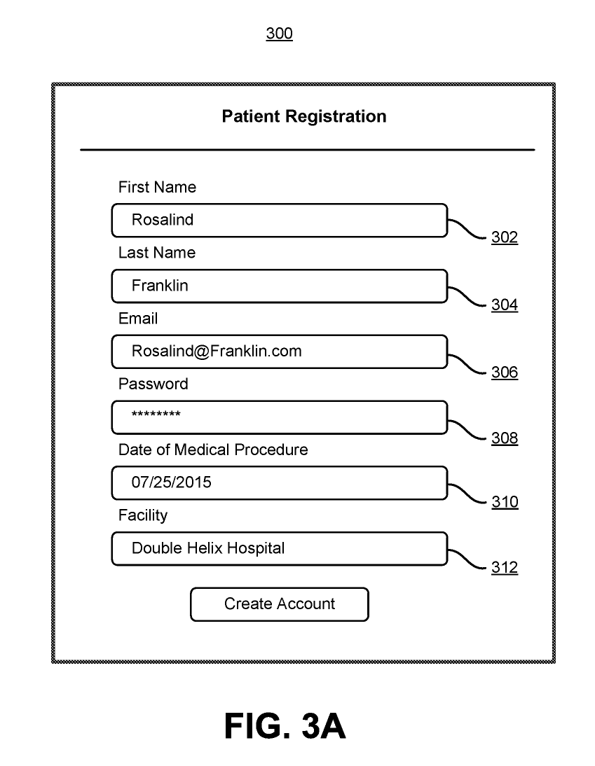

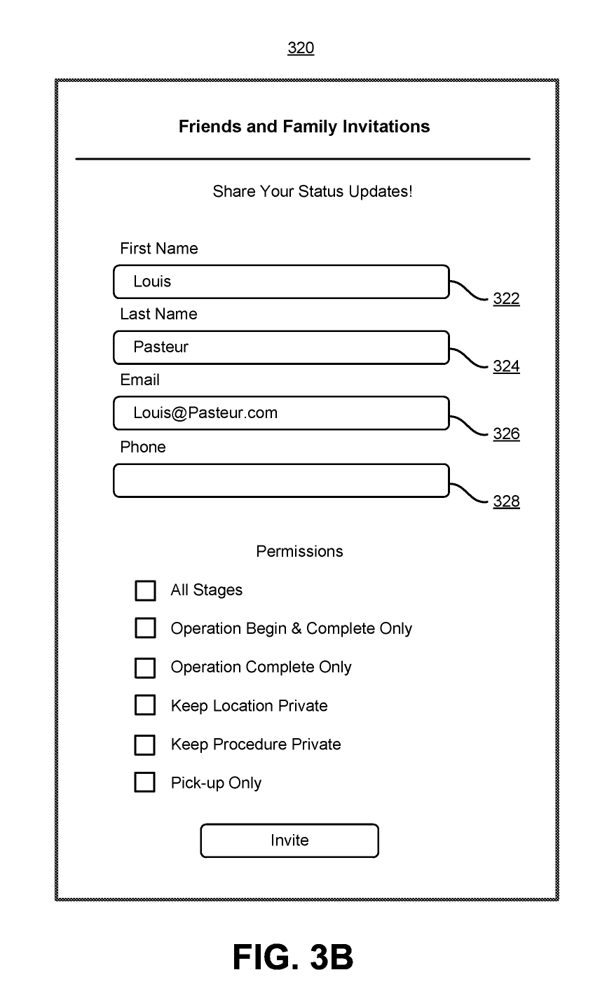

The patient registration module 225 may be configured to generate instructions to guide a patient undergoing a medical procedure through a registration process. In an embodiment, the patient registration module 225 provides (e.g., via the user interface manager 210) the instructions to a client device 110A of a patient 120 for display on a user interface (e.g., the user interface 300 further described in FIG. 3A and the user interface 320 further described in FIG. 3B) of the client device 110A. The instructions instruct the patient to provide registration information and/or information about the patient to the system 100. Further, the instructions instruct the patient to provide invitation information about one or more users 130 associated with the patient (e.g., family members and friends of the patient), which the patient is inviting to receive status updates, to the system 100. In some embodiments, the patient registration module 225 receives one or more permissions from the patient. The one or more permissions indicate an amount and/or types of status updates to provide to one of the users associated with the patient. For instance, a permission indicates that a close family member (e.g., mother) of the patient should be provided all status updates about the patient. In another instance, a different permission indicates that a friend of the patient should only be provided status updates about the patient relevant to a discharge stage of the medical procedure. In other embodiments, permissions indicate that a family or friend may receive status updates regarding all stages, operation begin and complete stages only, operation complete stage only, or pick-up stage only. Further, based on the permissions, the healthcare communication system 100 keeps the location of the patient and/or family or friend private, or keeps the medical procedure of the patient private. The permissions can be changed, removed, and/or added over time, e.g., based on information received by the patient via a client device. In response to receiving the registration information, the information about the patient, and/or the invitation information, the patient registration module 225 generates a patient account associated with the patient. In an embodiment, the patient registration module 225 stores information associated with the patient account (i.e., the registration information, the information about the patient, and/or the invitation information) in the patient profiles store 230 and/or any other database accessible by the system 100.

The patient profiles store 230 may be configured to store information received from patients 120 via client devices 110A, users 130 via client devices 110B, healthcare providers 140 via client devices 110C, and/or other sources such as an online database outside of the healthcare communication system 100 accessible via the network 150. Similarly, the healthcare content store 235 may be configured to store information received from patients 120 via client devices 110A, users 130 via client devices 110B, healthcare providers 140 via client devices 110C, and/or other sources such as an online database outside of the healthcare communication system 100 accessible via the network 150. The healthcare content store 235 stores information about medical procedures, clinical guidelines, among other types of healthcare information. The provider profile store 270 may be configured to store information received from patients 120 via client devices 110A, users 130 via client devices 110B, healthcare providers 140 via client devices 110C, and/or other sources such as an online database outside of the healthcare communication system 100 accessible via the network 150. The provider profile store 270 stores information about healthcare providers 140, e.g., which healthcare providers are available at a particular healthcare facility and the competencies, preferences, and work schedule of the healthcare providers.

The invitation module 240 may be configured to generate invitations to one or more users 130 associated with the patient 120. In an embodiment, the invitation module 240 retrieves invitation information from the patient profiles store 230 and generates the invitations based on the invitation information. In other embodiments, the invitation module 240 retrieves invitation information directly from the patient registration module 225. In an example, the invitation module 240 provides a generated invitation to the client device 110B of a user 130 associated with the patient that the patient has invited to receive status updates based on the invitation information. For instance, the invitation module 240 extracts an email address of the user from the invitation information and sends the generated invitation via an email message to the email address of the user, which the user then views on the client device 110B. In another embodiment, the invitation module 240 extracts a phone number of the user from the invitation information and sends a text message to the client device 110B of the user. In some embodiments, the generated invitation includes notification preference settings, e.g., checkboxes in a user interface allowing a user 130 to input notification preferences. The healthcare communication system 100 receives, via the generated invitation on a client device 110B of an invited user 130, the user's notification preferences. For example, the notification preferences indicate whether the user 130 wants to receive status updates in the form of text messages, email, and/or other types of communication channels.

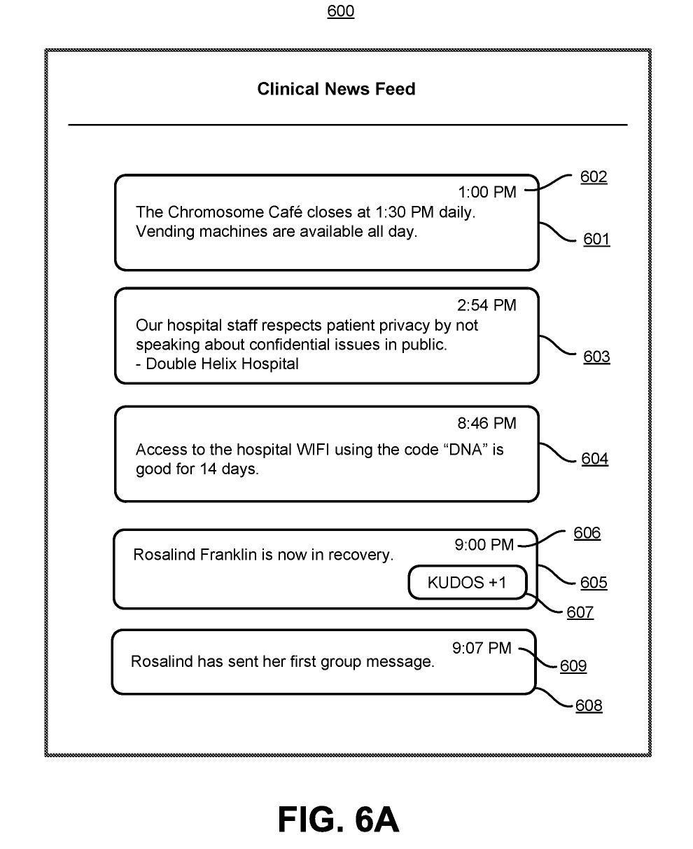

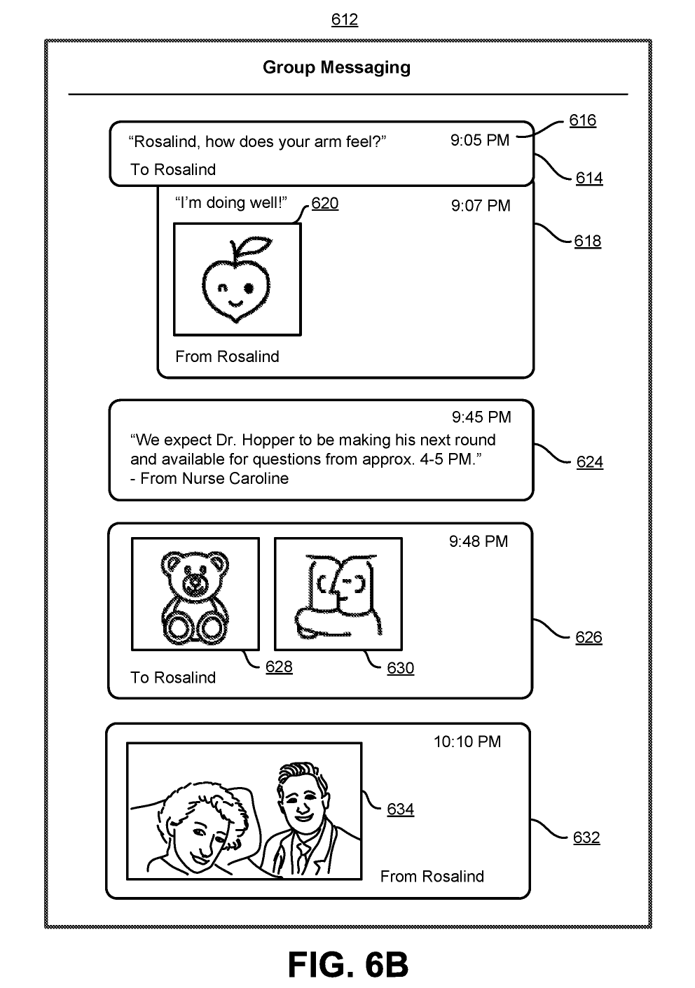

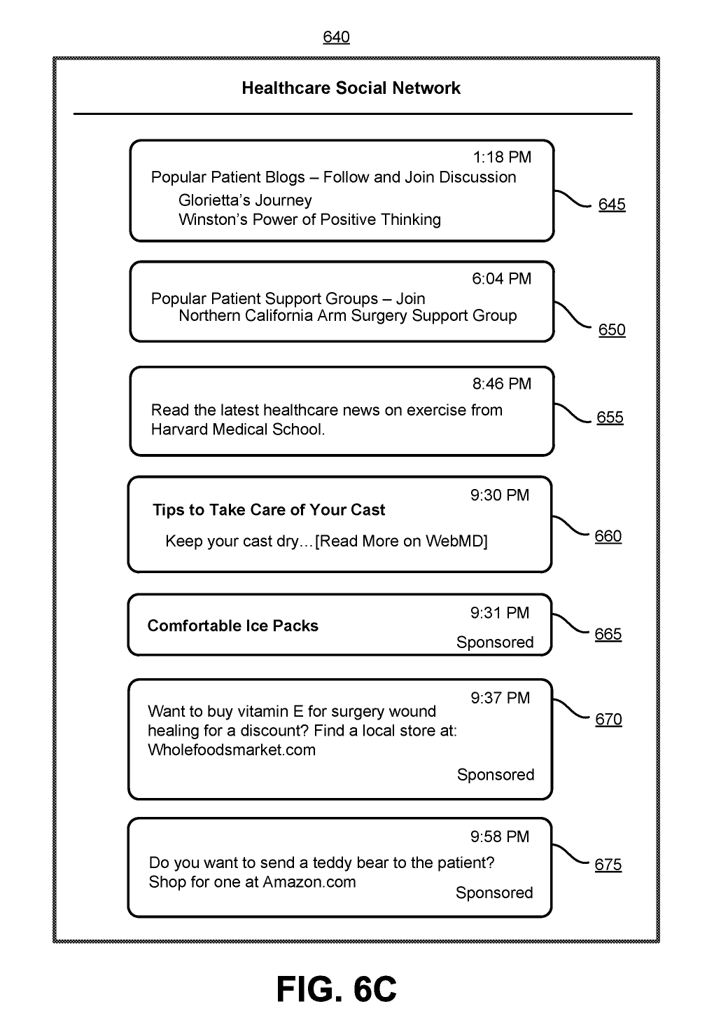

The messaging module 265 may be configured to generate messages for display in a user interface, e.g., the group messaging user interface further described in FIG. 6B. In one embodiment, the messaging module 265 receives messages input by patients 120 into client devise 110A, users 130 into client devices 110B, and/or healthcare provider 140 into client devices 110C. The messages may include clear text (e.g., text messages), emoticons and/or therapeutic oversized emoticons (e.g., from licensed libraries or originally designed emoticons) and/or multimedia (e.g., photos, GIFS, videos, etc.). In an embodiment, the messages include a timestamp indicating when each message was sent and/or received by the messaging module 265. The messaging module 265 encrypts information associated with the messages to serve as a technical safeguard for HIPAA compliance.

The messaging module 265 may receive input from a patient 120 and/or an invited user 130 designated by the patient (e.g., a “designated controller”) indicating message preferences. The message preferences include, for example, group information. Based on the group information, the messaging module 265 organizes messages into groups and/or subgroups of the patient 120, users 130, and/or healthcare providers 140. For instance, a subgroup includes the patient 120 and users 130 who are family members only, and another subgroup includes the patient 120 and a healthcare provider 140 (e.g., the patient's primary doctor) only. In another example, the message preferences include photo sharing controls. Based on the photo sharing controls, the messaging module 265 sets attributes for message photos as shareable or non-shareable, disappearing or non-disappearing with timer settings (e.g., 1 minute to 1 hour), save-able or non-save-able, screenshot-able or non-screenshot-able, etc. In yet another example, the message preferences indicate that only the patient 120 and a “designated controller” user 130 may directly communicate one-on-one with the healthcare providers 140.

The patient 120 may provide a doctor's excuse note from the healthcare communication system 100 to an employer or another authority as proof that the patient underwent or is undergoing a medical procedure. In an embodiment, in response to receiving input indicating that the patient 120 is requesting a doctor's note, the messaging module 265 generates an encrypted “one-to-one” direct message including the doctor's note. The messaging module 265 securely sends the direct message from the doctor (e.g., the healthcare provider 140) to the patient. The patient 120 may download the direct message from the healthcare communication system 100 to a client device 110A.

The healthcare social network module 245 may be configured to generate content items for display in a social network user interface, e.g., the healthcare social network further described in FIG. 6C. In one embodiment, the healthcare social network module 245 extracts information from the healthcare content store 235, provider profile store 270 and/or the patient profiles store 230 to generate the content items. For instance, the extracted information from the patient profiles store 230 indicates that a patient is undergoing arm surgery; the extracted information from the healthcare content store 235 includes a mapping of different types of medical procedures to different post-procedure guidelines. For example, arm surgery is mapped to guidelines about cast care instructions, and leg surgery is mapped to guidelines about wheelchair usage. Based on the mapping, the content generator module 250 identifies information likely to be relevant to a viewer (the patient 120, the user 130, and/or the healthcare provider 140) to include in content items. For instance, the healthcare social network module 245 generates a content item including tips (e.g., from an online source such as WebMD®) to care for an arm cast for display (via the user interface manager 210) to the patient who has just underwent arm surgery. In an embodiment, the healthcare social network module 245 creates a timestamp for each generated content item.

The content generator module 250 may be configured to generate content items for display in a news feed user interface, e.g., the clinical news feed further described in FIG. 6A. The clinical news feed may be referred to as “Procedure Updates.” In some embodiments, the content generator module 250 receives information from healthcare providers 140 (e.g., via input to the client device 110C and/or previously stored on the healthcare content store). Based on the information, the content generator module 250 generates content items including clinical pre-procedure guidelines and/or instructions, discharge guidelines and/or instructions, and/or post-acute care coordination. For instance, pre-procedure instructions indicate that a patient should not eat anytime 10 hours prior to starting a medical procedure. In another example, discharge instructions indicate illustrations of wound care, rehabilitative exercises, recommended nutrition intake, potential side effects of a particular medical procedure, and the like. In another instance, post-acute care coordination includes information to help manage prescriptions for the patient (e.g., antibiotic drugs), schedule follow-up appointments, and the like.

The gifts module 255 may be configured to generate content items for display in a user interface, e.g., the healthcare social network further described in FIG. 6C. In one embodiment, the gifts module 250 extracts information from the healthcare content store 235, the patient profiles store 230, provider profile store 270, and/or other modules of the healthcare communication system 100 to generate the content items. For example, the extracted information from the patient profiles store 230 indicates that a patient 120 is undergoing arm surgery; the extracted information from the healthcare content store 235 includes a mapping of products that patients typically use based on the types of medical procedures that the patients underwent. Thus, for the patient who is undergoing arm surgery, the gifts module 255 generates a content item including a link to purchase large ice packs for the patient, e.g., because ice packs help numb pain in an arm after arm surgery, but large ice packs that wrap around the arm may not be readily available at the healthcare facility and/or patient's home. In a different example, if the health care communication system 100 has received explicit permission from a patient 120, the gifts module 250 extracts information from the patient profiles store 230 indicating that the patient 120 is undergoing a certain medical procedure and needs suppliers and/or supplemental healthcare and wellness providers (e.g., massage therapist, chiropractor, acupuncturist, yoga instructor, etc.), e.g., because the extracted information includes a selection of a “partial knee replacement surgery” type of medical procedure. Accordingly, for the patient, the gifts module 255 generates a content item including a link to candidate suppliers and/or supplemental healthcare and wellness providers nearby the healthcare facility at which the patient is located. In yet a different example, the gifts module 250 generates content items that are likely relevant to a general population of patients 120, users 130, and/or healthcare providers 140. For instance, family and friends of patients at undergoing medical procedures at hospitals often bring gifts to the patients to cheer up the patients and wish the patients a speedy recovery from the patients' medical procedures. Therefore, the gifts module 255 generates a content item including a link to purchase gifts such as teddy bears, candy, pillows, blankets, balloons, food, drinks, and the like. In some embodiments, the gifts module 255 generates content items including sponsored content, e.g., from a third party. In an embodiment, the gifts module 255 creates a timestamp for each generated content item. In some embodiments, the gifts module 255 generates content items based on languages (e.g., Spanish, Chinese, Japanese, etc.) spoken by the patient 120 or based on the patient's ethnic background. For example, based on cultural traditions, Japanese speaking people often gift Akita dog statutes—which are said to symbolize inner strength—to their loved ones (e.g., patients 120) when they are sick as a wish for a speedy recovery.

In an embodiment, the gifts module 255 collects funds from users 130 to cover medical expenses associated with the patient 120. The gifts module 255 receives input from the patient 120 indicating that the patient wants to fundraise from family and friends (i.e., users 130). Thus, the gifts module 255 sends fundraising requests to the family and friends. The gifts module 255 collects funds from the family and friends through a secure channel directly from personal bank accounts and credit cards, or indirectly via third party applications such as PayPal® and Tilt. The gifts module 255 holds the collected funds in an escrow bank account and transfers the funds to a personal bank account of the patient 120.

The survey module 260 may be configured to generate surveys for patients 120, users 130, and healthcare providers 140. The survey module 260 provides the surveys to a viewer via a client device, e.g., the patient 120 views the survey on the client device 110A. The surveys include questions for the viewer, e.g., “how was your experience at the hospital?” or “how long did you wait at check-in?” The survey module 260 receives the viewer's response to the survey questions via the client device and stores the response in the patient profiles store 230 and/or the provider profile store 270.

### Registration Process

FIG. 3A shows a user interface 300 of a registration process of the healthcare communication system 100 according to one embodiment. The user interface 300 shown in FIG. 3A, e.g., generated by the patient registration module 225, includes text boxes for a patient undergoing a medical procedure to input registration information and/or information about the patient. In particular, the user interface 300 includes text box 302 to input a first name of the patient (e.g., Rosalind), text box 304 to input a last name of the patient (e.g., Franklin), text box 306 to input an email address of the patient (e.g., Rosalind@Franklin.com), text box 308 to input a password associated with the patient, a text box 310 to input a date of the medical procedure (e.g., Jul. 25, 2015), and a text box 312 to input a healthcare facility where the patient will undergo the medical procedure (e.g., Double Helix Hospital). For a medical procedure that requires more than one day, the input date is, e.g., the start date of the medical procedure. In some embodiments, additional, fewer, and/or different types of information (e.g., emergency contact information, allergy information, pre-existing conditions, medical insurance information, and the like) associated with the patient and/or the medical procedure may be input into text boxes of the user interface 300. Further, in some embodiments, the user interface 300 includes data input forms other than text boxes for the patient to input information, e.g., drop-down menus, a graphical calendar, radio buttons, checkboxes, and the like. In some embodiments, a user associated with the patient, rather than the patient, inputs the registration information and/or information about the patient, e.g., because the patient is disabled and would have difficulty interacting with a client device. In an embodiment, the healthcare communication system 100 generates a provider user interface similar to user interface 300 for healthcare providers 140 to register on the healthcare communication system 100. The healthcare communication system 100 categorizes healthcare providers 140 during registration into categories such as nurse, medical assistant, doctor, or administrator.

FIG. 3B shows a user interface 320 of an invitation process of the healthcare communication system 100 according to one embodiment. The user interface 320 shown in FIG. 3B e.g., generated by the patient registration module 225, includes text boxes for a patient 120 undergoing a medical procedure to input invitation information. Invitation information includes information about a user 130 associated with the patient that the patient is inviting to receive status updates about the patient and the medical procedure. In particular, the user interface 320 includes text box 322 to input a first name of the user (e.g., Louis), text box 324 to input a last name of the user (e.g., Pasteur), text box 326 to input an email address of the user (e.g., Louis@Pasteur.com), and text box 328 to input a phone number of the user. In some embodiments, additional, fewer, and/or different types of invitation information (e.g., phone number, address, best time to contact, relation to the patient, etc.) associated with the user may be input into text boxes of the user interface 320. Further, in some embodiments, the user interface 320 includes data input forms other than text boxes for the patient to input information, e.g., drop-down menus, a graphical calendar, radio buttons, checkboxes, and the like.

In some embodiments, the healthcare communication system 100 receives, via the user interface 320, input from a patient 120. The healthcare communication system 100 saves the input in the patient profiles store 230. In one example use case, the input designates administrative privileges to invited users 130, for example, to manage the patient's contact list, invite additional users, set sharing permissions, and the like. In another example, the input designates a post-surgery notifications arbiter. The healthcare communication system 100 first contacts the post-surgery notifications arbiter to report an outcome of the patient's medical procedure before notifications are sent to other invited users 130. In yet another example, the input designates a user 130 (e.g., a family member) to manage obtaining prescriptions for the patient's medical procedure (e.g., antibiotics for a surgery) and/or follow-up appointments.

The user interface 320 may be integrated using application programming interfaces with third party applications such as cross platform address databases, calendars, and maps. For instance, if the healthcare communication system 100 receives explicit permission from a patient 120, the healthcare communication system 100 receives contact information of the patient's friends and family from a third party address database application account associated with the patient. Based on the contact information, the healthcare communication system 100 may recommend users 130 for the patient 120 to invite to the system 100, e.g., by presenting invitation recommendations on the user interface 320.

### Patient Tracking Board

FIG. 4 shows a patient tracking board 400 of the healthcare communication system 100 according to one embodiment. In FIG. 4, the patient tracking board 400 user interface layout includes sections for a pending 410, check-in 420, pre-op 430, in surgery 440, recovery 450, admission 460, and discharge 470 stage of a medical procedure. Some embodiments of the patient tracking board 400 may have additional, fewer, and/or different sections (i.e., stages) than the ones described herein. For example, the pending 410 stage may be called the registered 410 stage or the expected 410 stage instead. The patient tracking module 105 may further divide stages into sub-stages to provide more granularity, e.g., the pending 410 stage includes a registered sub-stage and an expected sub-stage. Thus, the patient tracking module 105 accommodates, e.g., for tracking patients as needed per varying statuses in the patient profiles store 230 of registered, day of surgery, rescheduled, and discharged. The patient tracking module 105 generates the patient tracking board 400, which includes one or more markers each indicating a current stage of a medical procedure of a patient. In the embodiment shown in FIG. 4, the patient tracking board 400 includes markers for the following patients: Marie Curie 472, Alan Turing 474, George Washington Carver 476, Ada Lovelace 478, Rosalind Franklin 480, and Nikola Tesla 482. In particular, Marie Curie 472 and Alan Turing 474 are in the pending 410 stage, George Washington Carver 476 is in the check-in 420 stage, Ada Lovelace 478 is in the in surgery 440 stage, Rosalind Franklin 480 is in the recovery 450 stage, and Nikola Tesla 482 is in the discharge 470 stage. The patient tracking module 105 displays the scheduled patients in the pending stage 410 (or expected stage) on the patient tracking board 400 at 12:00 AM on the day of surgery. At 11:59 PM on the day of surgery, the patient tracking module 105 clears the patient tracking board 400 of the day's patients. Patient markers on the patient tracking board 400 may include a link to additional information about an individual patient 120. For example, a healthcare provider 140 interacting with the patient tracking board 400 on a laptop client device 110C double clicks a patient marker for the patient 120 to view another user interface to manage the patient. In some embodiments, the sections for the stages of the medical procedure are displayed in different medically appropriate colors to provide an easy-to-read user interface layout, e.g., a user interface layout that a healthcare provider can view to quickly determine stages of patients. In an embodiment, the patient tracking board 400 includes markers corresponding to one or more patients scheduled to undergo a medical procedure, undergoing a medical procedure, and/or who have completed a medical procedure at a health care facility. Healthcare providers 140 of the health care facility (e.g., doctors, nurses, secretaries, support staff, etc.) can view and interact with the patient tracking board 400 user interface via the client device 110C.

In an example use case, the patient tracking module 105 receives input from the healthcare provider 140 indicating a change of a stage of the patient 120, e.g., the health care provider interacts with patient tracking board 400 to provide the input. For instance, the patient tracking board 400 user interface is displayed on a laptop computer (i.e., the client device 110C), and the healthcare provider uses a touchpad and/or a keyboard of the laptop computer to indicate the change of the stage. In another example, the patient tracking board 400 user interface is displayed on a tablet device (i.e., the client device 110C), and the healthcare provider uses a touchscreen of the tablet to indicate the change of the stage, e.g., the healthcare provider performs a drag-and-drop motion using the tablet. Upon receiving an indication of a change of stage, the patient tracking module 105 displays, via a pop-up window on the patient tracking board 400, user-selectable options for additional information such as the room number at the healthcare facility where the patient 120 is located or whether the patient 120 is ready for visitors such as family and friends. In particular, the healthcare provider first places a finger on a marker of the patient tracking board 400 user interface corresponding to a patient, e.g., the portion in the recovery 450 stage corresponding to the marker of the patient Rosalind Franklin 480. Next, the healthcare provider moves the finger to a different portion of the patient tracking board 400 user interface, e.g., the portion in the admission 460 stage, to indicate that patient Rosalind Franklin 480 has changed from the recovery 450 stage to the admission 460 stage.

In another example use case, once a patient 120 has registered and indicated that the patient will be undergoing a medical procedure at a healthcare facility, the patient tracking module 105 generates a marker associated with the patient for display on the patient tracking board 400 under the pending 410 stage. Healthcare providers 140 at the healthcare facility can then promptly see that the patient is pending on the upcoming the patient tracking board 400.

### Patient Progress Bar

FIG. 5A shows a patient progress bar 500 of the healthcare communication system 100 according to one embodiment. In FIG. 5A, the patient progress bar 500 user interface layout includes sections for a check-in 510, pre-op 520, in surgery 530, recovery 540, admission 550, discharge 560, and home 570 stage of a medical procedure of a patient 120. Some embodiments of the patient progress bar 500 may have additional, fewer, and/or different sections (i.e., stages) than the ones shown in FIG. 5A. For instance, the patient progress bar 500 includes the admission 550 stage if the patient has planned in-patient procedures or out-patient procedures (e.g., as a consequence on the day of surgery in treatment for the patient to be admitted to the hospital overnight). In some embodiments, the patient progress bar 500 includes the home 570 stage only for patients 120 and users 130 associated with the patients 120 (i.e., not for healthcare providers 140). Further, in one example use case, only patients 120 or a particular invited user 130 (e.g., a “designated controller”) may update information corresponding to the home 570 stage. For instance, after the patient 120 is past the discharge 560 stage, the patient tracking module 105 receives an “I'm home” input from the patient 120. Based on the input, the healthcare communication system 100 sends a notification to all registered users 130 (e.g., friends and family) indicating that the patient is home. In an embodiment, one or more stages of the patient progress bar 500 correspond to one or more stages of a patient tracking board (e.g., the patient tracking board 400 in FIG. 4) and/or the data is synchronized between the patient progress bar 500 and the patient tracking board. For instance, the check-in 510 stage corresponds to the check in 420 stage, the pre-op 520 stage corresponds to the pre-op 430 stage, the in surgery 530 stage corresponds to the in surgery 440 stage, the recovery 540 stage corresponds to the recovery 450 stage, the admission 550 stage corresponds to the admission 460 stage, and the discharge 560 stage corresponds to the discharge 470 stage. Some embodiments of the patient progress bar 500 may have additional, fewer, and/or different sections (i.e., stages) than the ones described herein, for example, a “change” stage when appropriate (e.g., the patient 120 changes a medical procedure). The patient tracking module 105 generates the patient progress bar 500, which is associated with a patient 120 undergoing a medical procedure at a health care facility, e.g., patient Rosalind Franklin corresponding to the marker Rosalind Franklin 480 shown in FIG. 4. A user 130 associated with the patient views and/or interacts with the patient progress bar 500, e.g., on the client device 110B, to receive status updates regarding the patient and the medical procedure of the patient. Further, the patient 120 can also view and/or interact with the patient progress bar 500, e.g., on the client device 110A, to receive status updates regarding himself or herself. In an embodiment, a patient 120 may be undergoing multiple medical procedures. In this instance, the healthcare communication system 100 generates a patient progress bar 500 for each medical procedure of the patient. In yet another embodiment, a user 130 may be associated with multiple patients undergoing medical procedures. In this instance, the healthcare communication system 100 generates a patient progress bar 500 displaying the day of surgery for each medical procedure of a patient associated with the user.

In the example shown in FIG. 5A, the patient progress bar 500 indicates that Rosalind Franklin has completed the check-in 510, pre-op 520, and in surgery 530 stages of the medical procedure (e.g., surgery to fix a broken arm) by displaying the word “completed” underneath the name of each completed stage. In some embodiments, the patient progress bar 500 indicates completed stages using other graphical features, e.g., displaying completed stages in a green color, displaying completed stages in a faded color or reduced brightness, and the like. Further, the patient progress bar 500 indicates that Rosalind Franklin is currently in the recovery 540 stage, as is indicated by displaying the word “current” underneath the name of the recovery 540 stage, as well as the avatar 590 of the patient in the portion of the patient progress bar 500 corresponding to the recovery 540 stage. In some embodiments, the patient progress bar 500 indicates the current stage using other graphical features, e.g., displaying the current stage in a highlighted or increased brightness (relative to other stages), displaying a different type of avatar in the current stage, and the like. Users 130 associated with a patient (e.g., family and friends of the patient) can view and interact with the patient progress bar 500 user interface corresponding to the patient via the client device 110B.

In an embodiment of the patient progress bar 500, an information icon 570 is displayed with each stage of the medical procedure. A user associated with a patient, e.g., Rosalind Franklin, can view information associated with each stage of the medical procedure at any time on the patient progress bar 500. In the example shown in FIG. 5A, information associated with the check-in 510 stage is displayed because the patient has completed the check-in 510 stage. Similarly, information associated with the pre-op 520 stage and the in surgery 530 stage are displayed because the patient has completed the pre-op 520 stage and the in surgery 530 stage. Information associated with the recovery 540 stage is displayed because the patient is currently in the recovery 540 stage, e.g., because the patient tracking board 400 also indicates that the patient Rosalind Franklin 480 is currently in the recovery 450 stage.

In an embodiment, example information associated with the check-in 510 stage include an indication that a patient 120 has checked into a health care facility (e.g., “Rosalind Franklin has completed check-in.”) and contact information to reach the patient and/or health care providers 140 at the health care facility (e.g., “Family members may call 111-222-3333 for more information”). Example information associated with the pre-op 520 stage include an indication that the patient is ready for surgery (e.g., “Rosalind Franklin has been prepared for surgery”). Example information associated with the in surgery 530 stage include information about the outcome of a medical procedure of the patient (e.g., “Rosalind Franklin's surgery successfully completed at 8:46 PM on July 25.”). Example information associated with the in recovery 540 stage include an indication that the patient is recovering from the medical procedure (e.g., “Rosalind Franklin is now in recovery.”) and information indicating where the patient is recovering (e.g., “Rosalind Franklin is in Room 37, 1^{st} floor.”). In some embodiments, the patient progress bar 500 includes a count-down timer indicating the expected time remaining until the patient 120 changes from the recovery stage 540 to the discharge stage 560, or between any two stages of the medical procedure. Example information associated with the admission 550 stage include information indicating that the patient has been admitted to the healthcare facility and the time of the admission (e.g., “Rosalind Franklin has been admitted at 8:46 PM.”). Example information associated with the discharge 560 stage include information indicating that the patient has been discharged from the health care facility and the time of the discharge (e.g., “Rosalind Franklin has been discharged at 12:00 PM.”). Example information associated with the home 570 stage include information indicating that the patient has returned home from the health care facility (e.g., “Rosalind Franklin is back at home.”). In some embodiments, the patient progress bar 500 includes information associated with the home 570 stage only for patients 120 and users 130 associated with the patients 120 (e.g., the consumer side and not the enterprise or healthcare provider 140 side).

FIG. 5B shows an intra-surgery status bar 591 of the healthcare communication system 100 according to one embodiment. The intra-surgery status bar 591 shown in FIG. 5B includes a 25% stage 592, 50% stage 593, 75% stage 594, and 100% stage 595. Each stage corresponds to a percentage milestone to illustrate progress of medical procedure of a patient 120. In other embodiments, the intra-surgery status bar 591 may include additional, fewer, and/or different stages, e.g., a 20% stage, 40% stage, 60% stage, etc. The 25% stage 592 and 50% stage 593 include the word “complete” because these two percentage milestones have been completed. The 75% stage 594 includes the phrase “in process” because this percentage milestone is currently ongoing and not yet complete. Further, the 75% stage 594 includes an avatar of a healthcare provider 140. The 100% stage 595 does not include “complete” or “in process” because the medical procedure is not yet complete or in process of completion.

The patient tracking module 105 generates and updates the intra-surgery status bar 591 based on a timer corresponding to the particular medical procedure of the patient 120, e.g., partial knee surgery. For example, patient tracking module 105 extracts information from the healthcare content store 235 indicating that partial knee surgery typically requires three hours of operation time. The expected time may be based on information specific to a healthcare facility, e.g., one healthcare facility performs a particular type of surgery faster than another healthcare facility due to different resources available at each healthcare facility. In an example use case, the patient tracking module 105 receives input, e.g., via a client device 110C, from a healthcare provider 140 indicating that the medical procedure is running overtime. Based on the input, the patient tracking module 105 adjusts the progress of the percentage milestones to provide an accurate and updated representation of the status of the patient's medical procedure.

### Clinical News Feed

FIG. 6A shows a clinical news feed 600 user interface of the healthcare communication system 100 according to one embodiment. In FIG. 6, the clinical news feed 600 user interface layout includes several content items generated by the content generator module 250 (i.e., content items 601, 603, 604, 605, and 608) associated with a patient 120, i.e., Rosalind Franklin (corresponding to Rosalind Franklin 480 in FIG. 4), a medical procedure of the patient, e.g., surgery to repair a broken bone in an arm, and/or the healthcare facility of the patient. In some embodiments, each content item of the clinical news feed 600 has a timestamp, i.e., the time at which the content item is generated and/or first displayed on the clinical news feed 600. For instance, content item 601 has a timestamp 602 of 1:00 PM.

The clinical news feed 600 displays content items associated with the healthcare facility if the patient 120 indicates that family and friends (e.g., users 130) will be visiting the patient at the healthcare facility. Specifically, content items 601, 603, and 604 include information associated with the healthcare facility. In particular, content item 601 indicates a closing time of a café at the healthcare facility and other options for food and drinks at the healthcare facility. Content item 603 indicates the healthcare facility's emphasis on patient privacy, e.g., as an administrative safeguard for HIPAA compliance. Content item 604 includes information about the WIFI network available at the healthcare facility.

The clinical news feed 600 displays content items associated with the patient 120. Specifically, content item 605 indicates a change in a stage of a medical procedure of a patient 120, i.e., “Rosalind Franklin is now in recovery,” at a time indicated by the timestamp 9:00 PM 606. Further, the content item 605 also includes an indication of a “kudos” 607 associated with the content item 605. In particular, the healthcare communication system 100 received input from a patient 120, a user 130 associated with the patient, or a healthcare provider 140 associated with the patient (e.g., via a client device) indicating a graphical representation of a “kudos”, i.e., an expression of congratulations, praise, or similar emotions. The clinical news feed 600 may accumulate kudos for each content item (e.g., “kudos +2,” “kudos +3,” etc.). Content item 608 indicates that the patient 120 has sent her first group message, e.g., via the group messaging user interface further described in FIG. 6B, at a timestamp 609 of 9:07 PM.

In some embodiments, the clinical news feed 600 includes information about the healthcare providers 140 treating the patient 120 and the healthcare facility where the patient is undergoing a medical procedure. In particular, the information may include photos and biographical data about doctors, nurses, and the like, at the healthcare facility. The information may also include historical data about the healthcare facility (e.g., statistics about the success rate of medical procedures completed at the healthcare facility, demographics of patients at the healthcare facility, information about medical resources and equipment at the healthcare facility, founding and/or origin story of the healthcare facility, etc.) and data about a healthcare system of the healthcare facility. In some embodiments, the healthcare communication system 100 presents the information about the healthcare providers 140 and the healthcare facility in a different user interface separate from the clinical news feed 600.

### Secure Group Messaging

FIG. 6B shows a group messaging 612 user interface of the healthcare communication system 100 according to one embodiment. The user is assured that all group messaging is secure, encrypted, and protected for HIPAA compliance. In particular, the healthcare communication system 100 does not perform “data mining” on information from messages (e.g., messages in transmission over the network 150 or messages stored on a database or client device) of the group messaging 612 user interface. The group messaging 612 user interface includes messages associated with a patient 120, i.e., Rosalind Franklin (corresponding to Rosalind Franklin 480 in FIG. 4), and/or a medical procedure of the patient, e.g., surgery to repair a broken bone in an arm. In some embodiments, each message has a timestamp, i.e., the time at which the message is generated and/or first displayed on the group messaging 612 user interface. The message 614 includes a message, i.e., “Rosalind, how does your arm feel?” sent from a user 130 associated with the patient 120 (e.g., a friend of the patient such as Louis Pasteur in FIG. 3B) to the patient. The message 614 has a timestamp 616 of 9:05 PM. The message 618 includes a message, i.e., “I'm doing well!” sent from the patient 120 to the user 130 associated with the patient, responding to the message 614. Message 618 also includes an oversized emoticon 620 (e.g., a smiling face indicating positive emotion) provided by the patient. The message 624 includes a message, i.e., “We expect Dr. Hopper to be making his next round and available for questions from approx. 4-5 PM,” sent from a health care provider 140 (e.g., a nurse) associated with the patient. The message 626 includes a first oversized emoticon 628 of a teddy bear and a second oversized emoticon 630 of a hug sent from the user 130 to the patient 120, e.g., to convey the user's emotions to the patient via the group messaging 612 user interface. The message 632 includes a photo 634, e.g., a non-shareable photo that is removed (e.g., “disappears”) from the group messaging 612 user interface after a predetermined duration of time (e.g., one hour). For instance, the patient takes the photo 634 of herself next to her doctor using a camera of a mobile phone client device 110A and uploads the photo to the health care communication system 100 via a user interface of the client device 110A. In some embodiments, as a convenience to the healthcare facility, from the day of the medical procedure of the patient 120 until discharge of the patient, the patient is restricted from taking photos. In some embodiments, the messages include indication of a “kudos” substantially the same as the “kudos” described in FIG. 6A.

### Healthcare Social Network

FIG. 6C shows a healthcare social network 640 user interface of the healthcare communication system 100 according to one embodiment. The healthcare social network 640 may also be referred as the healthcare community network. The healthcare social network 640 includes content items associated with a patient 120, i.e., Rosalind Franklin (corresponding to Rosalind Franklin 480 in FIG. 4), a medical procedure of the patient, e.g., surgery to repair a broken bone in an arm, and/or a healthcare facility. In some embodiments, each content item has a timestamp, i.e., the time at which the content item is generated by the healthcare social network module 245 and/or first displayed on the healthcare social network 640.

Generally, the healthcare social network 640 user interface includes content items related to various healthcare or wellness online sources. Specifically, content item 645 includes information about popular patient blogs such as “Glorietta's Journey” and “Winston's Power of Positive Thinking.” The content generator module 250 generates the content items, e.g., based on information associated with the medical procedure of the patient 120. In particular, content item 650 includes information about popular patient support groups such as the “Northern California Arm Surgery Support Group” because the patient 120 Rosalind Franklin (shown in FIG. 6B) underwent arm surgery. Content item 655 includes a link to a website or a published document including healthcare news from Harvard Medical School. Content item 660 includes information about “tips to take care of your cast” such as “keep your cast dry,” which are likely to be useful for the patient 120 who has underwent surgery to repair a broken bone in an arm, e.g., because patients who undergo arm surgery typically have to wear a cast for a period of time following the surgery. Further, content item 660 includes a link, i.e., “[Read More]”, to a WebMD® website including more information about “tips to take care of your cast.”

The healthcare social network 640 user interface also includes content items including sponsored content from third parties. The gifts module 255 generates content items based on sponsored content that is likely to be of interest to the patient 120. In particular, the patient, Rosalind Franklin shown in FIG. 6B, who underwent surgery to repair a broken bone in an arm is likely to want ice packs to numb potential pain in the arm. Thus, the content item 665 includes a link, i.e., “Comfortable Ice Packs”, to a third-party website where the patient 120 (or a user 130 or healthcare provider 140 associated with the patient) can purchase ice pack products. Content item 670 includes information about local products to help heal a surgery wound. In some embodiments, the gifts module 255 interfaces with a global positioning system (GPS) application of a client device 110A or 110B to identify vendors (e.g., Whole Foods Market®) nearby the healthcare facility of the patient 120. Based on the vendors, the gifts module 255 generates content items, e.g., including information about vitamins for sale at a local drugstore or bouquets for sale at a local florist. Content item 675 includes an advertisement to purchase a teddy bear for the patient 120. In one example, the gifts module 255 receives information from third-party vendors (e.g., Amazon.com) via an application programming interface (API) to generate indications about purchased gifts and order statuses. The gift can also be an e-gift, such as an electronic get-well card, a funny or uplifting video or photo, among other options.

In an embodiment, content from the clinical news feed 600 user interface, the group messaging 612 user interface, and/or the healthcare social network 640 user interface correspond to one or more stages of a patient tracking board (e.g., the patient tracking board 400 in FIG. 4) and/or one or more stages of a patient progress bar (e.g., the patient progress bar 500 in FIG. 5A). Further, data may be synchronized between the patient progress bar 500, the patient tracking board 400, the clinical news feed 600, the group messaging 612, and/or the healthcare social network 640. For instance, a healthcare provider 140 of a patient 120, i.e., Rosalind Franklin (corresponding to Rosalind Franklin 480 in FIG. 4), indicates that Rosalind Franklin has transitioned from the in surgery 530 stage to the recovery 540 stage by providing input to the healthcare communication system 100 via the patient tracking board 400 on the client device 110C. As a result, the patient tracking module 105 generates content item 605 (shown in FIG. 6A) and provides content item 605 for display (e.g., via the user interface manager 210) on the client device 110B of a user 130 associated with the patient. The display occurs immediately (or soon after the healthcare provider's input to the client device 110C) in the clinical news feed 600, to provide a prompt indication of a transition of a stage of a medical procedure of Rosalind Franklin to the user associated with Rosalind Franklin.

In an embodiment, the clinical news feed 600, group messaging 612, and/or healthcare social network 640 user interfaces are associated with one or more patients 120, where each patient is undergoing a medical procedure at a health care facility, e.g., patient Rosalind Franklin corresponding to the marker Rosalind Franklin 480 and patient Nikola Tesla corresponding to the marker Nikola Tesla 482 shown in FIG. 4. In one embodiment, users 130 associated with a patient 120 (e.g., family and friends of the patient) can view and interact with clinical news feed 600, group messaging 612, and/or healthcare social network 640 user interfaces associated with the patient via the client device 110B. In another embodiment, patients 120 can view and interact with clinical news feed 600, group messaging 612, and/or healthcare social network 640 user interfaces associated with the patient (i.e., himself or herself) via the client device 110A. In yet another embodiment, healthcare providers 140 of a patient can view and interact with clinical news feed 600, group messaging 612, and/or healthcare social network 640 user interfaces associated with the patient via the client device 110C, e.g., to be aware of notices sent across healthcare provider staff shift changes. The clinical news feed 600 user interface may be customized based on the viewer of the clinical news feed 600 (e.g., the patient 120, users 130, and/or the healthcare providers 140). For instance, content items of the clinical news feed 600 include information about gifts when the viewer is a user 130 associated with the patient 120 but not when the viewer is the patient, e.g., because the patient is unlikely to purchase a gift for herself.

### Healthcare Provider Metrics

FIG. 7 shows a healthcare provider metrics 700 user interface of the healthcare communication system 100 according to one embodiment. The embodiment shown in FIG. 7 includes metrics 710 about the total users (e.g., patients 120, users 130, and/or healthcare providers 140) of the healthcare communication system 100 and a graph 720 indicating check-in duration times. Other embodiments of the healthcare provider metrics 700 user interface may include additional, fewer, and/or different metrics and/or graphical representations of metrics (e.g., pie graphs, line graphs, histograms, etc.) than the ones shown in FIG. 7. Different metrics include, e.g., statistics of users of the healthcare communication system 100. For instance, the statistics indicate time ranges of the day during which users are most active on the healthcare communication system 100, or a types of internet browsers users use to interact with the healthcare communication system 100. The statistics may be categorized based on factors such as demographic information, e.g., statistics for 13-21 year old users are separate from statistics for 22-30 year old users. The statistics may also be based on responses to questions received by the survey module 260, e.g., responses indicating patient satisfaction at a given healthcare facility. Based on information in the healthcare communication system 100, e.g., information from the patient profiles store 230, healthcare content store 235, and/or provider profile store 270, the patient tracking module 105 generates and provides the healthcare provider metrics 700 to the client device 110C for display to healthcare providers 140.

In the embodiment shown in FIG. 7, the metrics 710 indicate that the total users of the healthcare communication system 100 include 7 healthcare providers (i.e., healthcare providers 140), 20 patients (i.e., patients 120), and 15 family & friends (i.e., users 130). Further, the metrics 710 indicate that 90% of invited patients register, 72% of patients self-register, and 75% of friends self-register, e.g., by interacting with the healthcare communication system 100 using a client device 110A, 110B, and/or 110C. Additionally, the metrics 710 indicate that the healthcare communication system 100 transmits an average of 5 messages per medical procedure, 47% of users interact with the healthcare communication system 100 on a mobile device (e.g., client device 110A, 110B, or 110C), and healthcare providers 140 spend an average of 2.5 hours each day using the healthcare communication system 100. The graph 720 indicates the check-in duration times of patients 120 at a healthcare facility using the healthcare communication system 100 (e.g., corresponding to the check-in 420 stage in FIG. 4 and the check-in 510 stage in FIG. 5A). In particular, the x-axis of the graph 720 represents dates of a current week (i.e., April 4, April5, April 6, and April 7) and the y-axis of the graph 720 represents the average check-in time in minutes for a given day of the week. For instance, the average check-in time for April 7 is 1 minute. The graph 720 also includes a statistic indicating that the average check-in time for the current week is 1.4 minutes. In other embodiments, the healthcare provider metrics 700 include graphs indicating the average time patients spend at each stage of a medical procedure, e.g., the stages shown in the patient tracking board 400 in FIG. 4. The graphs and/or statistics may be based on data points that are de-identified from individual patients, e.g., to provide anonymity and security as a technical safeguard for HIPAA compliance.

### HIPAA Compliance

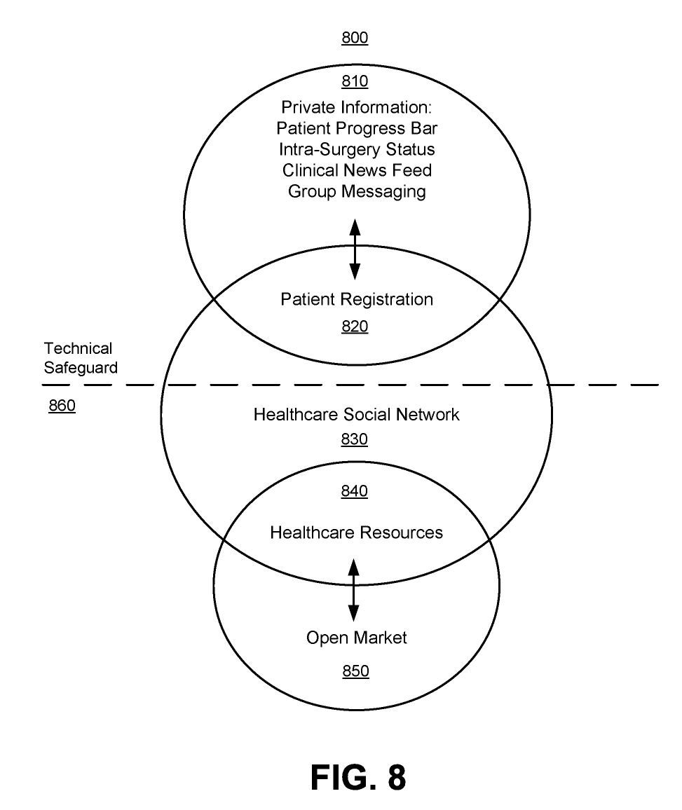

FIG. 8 is a data flow diagram 800 of the healthcare communication system 100 according to one embodiment. The data flow diagram 800 shown in FIG. 8 includes information corresponding to private information 810, patient registration 820, healthcare social network 830, healthcare resources 840, and open market 850. The private information 810 includes information about patient progress bars (e.g., for display in patient progress bar 500 in FIG. 5A), intra-surgery statuses (e.g., for display in intra-surgery status bar 591 in FIG. 5B), clinical news feeds (e.g., for display in clinical news feed 600 in FIG. 6A), and group messaging (e.g., for display in group messaging 612 in FIG. 6B). Only registered users of the healthcare communication system 100 with appropriate permissions, e.g., a “designated controller” user 130 selected by a patient 120 or the patient herself, may access the private information 810. In some embodiments, for privacy purposes, the healthcare communication system 100 does not track the private information 810. Based on patient registration 820 information (e.g., information received via the patient registration 300 user interface), the healthcare communication system 100 shares selected information from the private information 810 with the healthcare social network 830 (e.g., for display in healthcare social network 640 in FIG. 6C). For example, if the healthcare communication system 100 receives input indicating the patient's informed consent to share select information, the healthcare communication system 100 shares anonymized medical procedure types and patient demographics with the healthcare social network 830. The open market 850 includes, e.g., third party vendors and healthcare services such as massage therapists and drugstores. The healthcare communication system 100 shares select healthcare resources 840 from the open market 850 with the healthcare social network 830. The healthcare resources 840 include, e.g., healthcare related advice, resources, providers, suppliers, forum messages, sponsored content, and the like.

Based on the organization and control of data flow in the healthcare communication system 100, the healthcare communication system 100 implements a technical safeguard 860 for HIPAA compliance. In particular, HIPAA compliance requires technical safeguards, administrative safeguards, and physical safeguards. Technical safeguards include, e.g., encryption and decryption of secured information, emergency access protocols, controlled access to computer systems, user authentication, secure data storage, and the like. The healthcare communication system 100 controls access to protected health information (PHI) and electronic protected health information (EPHI) by separating the private information 810 from the healthcare social network 830. To access PHI and/or EPHI, users of the healthcare communication system 100 need to register (e.g., using the patient registration 300 user interface in FIG. 3A) and login using credentials associated with an account, e.g., a patient's account or an account of a user invited by the patient (e.g., using the user interface 320 of an invitation process in FIG. 3B) and having sufficient permissions granted by the patient. Administrative safeguards include, e.g., policies and procedures to secure PHI and/or EPHI. For example, a healthcare facility using the healthcare communication system 100 implements privacy training and oversight programs for healthcare providers who interact with PHI and/or EPHI. Physical safeguards include, e.g., data redundancy in servers storing healthcare records, controlled access to equipment storing health information, and healthcare facility security plans for visitors. For example, a healthcare facility using the healthcare communication system 100 only allows trained healthcare providers to access patient tracking boards (e.g., patient tracking board 400 in FIG. 4) on approved healthcare facility devices (e.g., client devices 110C) with a secure internet connection and located in non-public areas of the healthcare facility. Thus, the healthcare communication system 100 is HIPAA compliant because the system 100 supports technical safeguards, administrative safeguards, and physical safeguards.

### Process Flow

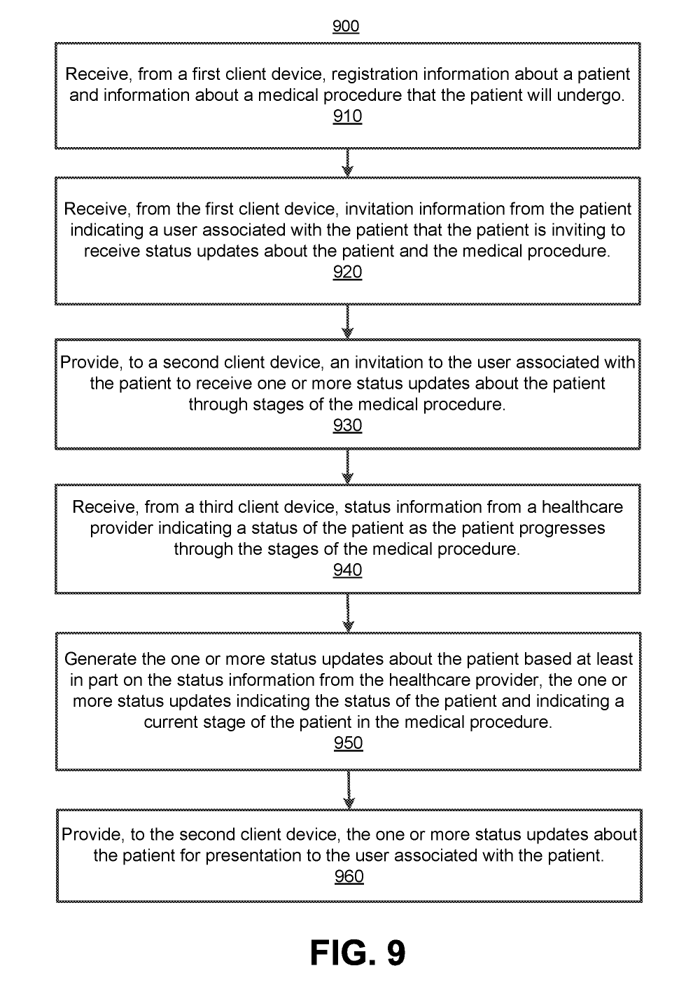

FIG. 9 is a flowchart of a process 900 of providing status updates of patients according to one embodiment. In some embodiments, the healthcare communication system 100 (e.g., modules of the healthcare communication system 100) uses the process 900 within the environment of FIG. 1. The process 900 may include different or additional steps than those described in conjunction with FIG. 9 in some embodiments or perform steps in different orders than the order described in conjunction with FIG. 9.

The patient registration module 225 receives 910, from a client device 110A of a patient 120, registration information about the patient and information about a medical procedure that the patient will undergo at a healthcare facility. The patient tracking module 105 automatically includes the patient's information on a patient tracking board (e.g., patient tracking board 400 in FIG. 4) on the day of surgery for a healthcare provider to access. The patient registration module 225 receives 920, from the client device of the patient, invitation information from the patient indicating a user 130 associated with the patient that the patient is inviting to receive status updates about the patient and the medical procedure. The invitation module 240 provides 930, to a client device 110B of the user associated with the patient, an invitation to the user to receive and/or respond to one or more status updates about the patient through stages of the medical procedure. The patient tracking module 105 receives 940, from a client device 110C of a healthcare provider 140, status information from the healthcare provider indicating a status of the patient as the patient progresses through the stages of the medical procedure. The patient tracking module 105 generates 950 the one or more status updates about the patient based at least in part on the status information from the healthcare provider. The one or more status updates indicating the status of the patient and indicating a current stage of the patient in the medical procedure. The patient tracking module 105 provides 960 to the client device of the user via the user interface manager 210 the one or more status updates about the patient for presentation to the user, e.g., presented on the patient progress bar 500 in FIG. 5A and/or the clinical news feed 600 in FIG. 6A.

The healthcare communication system 100 can provide a variety of other process flows, as well. For example, the registration process of a patient 120 can include receiving an indication of a registration of the patient 120 including patient information, medical procedure information, healthcare facility information, permission information, etc., creating a patient account for the patient 120 or retrieving an existing account for the patient 120, receiving an indication of users 130 (e.g., family members and/or friends) to be invited by the patient 120, sending invitations to the users 130, receiving acceptances of the sent invitations, adding the patient 120 to a patient tracking board (e.g., patient tracking board 400 in FIG. 4) on the day of a medical procedure along with other patients, generating notifications through the patient progress bar (e.g., patient progress bar 500 in FIG. 5A) for the patient 120, and the like. Thus, these steps can occur automatically such that the patient 120 and healthcare providers 140 have minimal work to do and the healthcare communication system 100 sets all of the pieces in motion for the medical procedure day. As another example, post-procedure interactions may include receiving indications from users 130 (e.g., family and/or friends) to send messages, send gifts, send kudos, and send photos, providing these to the patient 120 (e.g., ordering a gift to be delivered to a healthcare facility for the patient 120), receiving interactions by the patient 120, and forwarding the interactions to user 130 and/or healthcare providers 140, such that the healthcare communication system 100 coordinates and provides an open forum for easy interaction among all parties.

In an embodiment, when viewing the process flow described above from a client device standpoint for a client device of users 130 (e.g., client device 110B of family and friends), the process flow can include receiving an invitation from the healthcare communication system 100 to receive status updates about the patient 120 through stages of the medical procedure and following the medical procedure, sending an acceptance of the invitation, accepting designated roles (e.g., “designated controller” or “post-surgery notifications arbiter”) assigned by the patient, receiving the status updates over time as the medical procedure progresses and after it has completed, engaging with the healthcare social network 640, viewing healthcare facility announcements to visitors, participating in surveys, accessing procedure-related patient records, interacting with and/or sending messages, gifts, etc. to the patient 120 and to other users 130 (e.g., family members and/or friends), reviewing and/or interacting with the clinical news feed 600, etc. From the patient's 120 standpoint, the process flow can include registering with the healthcare communication system 100 including providing information about the patient 120, the medical procedure, the healthcare facility, designating roles to family and/or friends, engaging with the healthcare social network 640, viewing healthcare facility announcements to visitors, participating in surveys, accessing procedure-related patient records, providing information about users 130 (e.g., family and/or friends) or selecting candidate users 130 from a stored list to be invited to join a group of users, interacting with and/or messaging users 130 (e.g., family and/or friends) before and after the medical procedure, receiving gifts and kudos from users 130 (e.g., family and/or friends), reviewing and/or interacting with the clinical news feed 600, etc. From the healthcare provider's 140 standpoint, the process flow can include receiving an indication that a patient 120 had registered with the healthcare communication system 100 for a medical procedure to be performed at the healthcare facility of the healthcare provider 140, reviewing the patient tracking board 400 for information about patients having medical procedures on a given day, adjusting a patient status within the patient tracking board 400 interface such that status updates are sent out to invited users 130 (e.g., family and/or friends), and sending messages and/or other information to the users 130 (e.g., family and/or friends) and/or patient 120 regarding the medical procedure.

### Alternative Embodiments

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a nontransitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a nontransitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

We claim:

1. A computer-implemented method for providing information associated with a patient undergoing a medical procedure, comprising:
receiving, from a first client device, registration information about the patient and information about the medical procedure;
receiving, from the first client device, invitation information from the patient indicating a user associated with the patient that the patient is inviting to receive status updates about the patient and the medical procedure;
providing, to a second client device, an invitation to the user associated with the patient to receive one or more status updates about the patient through stages of the medical procedure;
receiving, from a third client device, status information from a healthcare provider indicating a status of the patient as the patient progresses through the stages of the medical procedure;
generating the one or more status updates about the patient based at least in part on the status information from the healthcare provider, the one or more status updates indicating the status of the patient and indicating a current stage of the patient in the medical procedure; and
providing, to the second client device, the one or more status updates about the patient for presentation to the user associated with the patient.

2. The method of claim 1, wherein receiving, from the first client device, the registration information about the patient further comprises:
providing a registration process to the first client device, the registration process including instructions for the patient to indicate a healthcare facility where the patient will undergo the medical procedure and to indicate information about the patient; and
providing the information about the patient to the third client device, wherein the third client device is used by a healthcare provider of the healthcare facility.

3. The method of claim 2, wherein providing the information about the patient to the third client device comprises displaying automatically on the third client device, in response to receiving input from the patient, a patient tracking board graphical user interface indicating that the patient is in a pending stage of the medical procedure.

4. The method of claim 1, wherein the invitation information includes a permission indicating a type of status update to be provided to the user associated with the patient, and wherein providing the one or more status updates about the patient to the user associated with the patient is based at least in part on the permission.

5. The method of claim 1, wherein receiving, from the third client device, the status information from the healthcare provider indicating the status of the patient comprises receiving an indication that the patient is in a stage of one of: registered, expected, check-in, pre-op, in surgery, recovery, admission, discharge, and home.

6. The method of claim 1, further comprising facilitating communication of one or more messages between the patient and the user associated with the patient, the one or more messages corresponding to a status update of the one or more status updates.

7. The method of claim 6, wherein the one or more messages indicate an emotion of the patient or the user associated with the patient.

8. The method of claim 1, wherein providing, to the second client device, the one or more status updates about the patient to the user associated with the patient comprises displaying the one or more status updates about the patient in a patient progress bar graphical user interface on the second client device.

9. The method of claim 1, further comprising:
generating one or more content items including information associated with the patient or the medical procedure; and
providing the generated one or more content items to the first client device for display to the patient.

10. The method of claim 9, further comprising providing the generated one or more content items to the second client device for display to the user associated with the patient.

11. The method of claim 9, wherein the generated one or more content items indicate a transaction of a gift purchased for or purchasable for the patient by the user associated with the patient.

12. The method of claim 9, wherein the generated one or more content items are based at least in part on a medical recommendation from the healthcare provider and provide information about the medical recommendation from the healthcare provider.

13. A non-transitory computer-readable storage medium storing executable computer program instructions, the computer program instructions comprising code for:
receiving, from a first client device, registration information about the patient and information about the medical procedure;
receiving, from the first client device, invitation information from the patient indicating a user associated with the patient that the patient is inviting to receive status updates about the patient and the medical procedure;
providing, to a second client device, an invitation to the user associated with the patient to receive one or more status updates about the patient through stages of the medical procedure;
receiving, from a third client device, status information from a healthcare provider indicating a status of the patient as the patient progresses through the stages of the medical procedure;
generating the one or more status updates about the patient based at least in part on the status information from the healthcare provider, the one or more status updates indicating the status of the patient and indicating a current stage of the patient in the medical procedure; and
providing, to the second client device, the one or more status updates about the patient for presentation to the user associated with the patient.

14. The computer-readable storage medium of claim 13, wherein receiving, from the first client device, the registration information about the patient further comprises:
providing a registration process to the first client device, the registration process including instructions for the patient to indicate a healthcare facility where the patient will undergo the medical procedure and to indicate information about the patient; and
providing the information about the patient to the third client device, wherein the third client device is used by a healthcare provider of the healthcare facility.

15. The computer-readable storage medium of claim 14, wherein providing the information about the patient to the third client device comprises displaying, on the third client device, a patient tracking board graphical user interface indicating that the patient is in a pending stage of the medical procedure.

16. The computer-readable storage medium of claim 13, wherein the invitation information includes a permission indicating a type of status update to be provided to the user associated with the patient, and wherein providing the one or more status updates about the patient to the user associated with the patient is based at least in part on the permission.

17. The computer-readable storage medium of claim 13, wherein receiving, from the third client device, the status information from the healthcare provider indicating the status of the patient comprises receiving an indication that the patient is in a stage of one of: registered, expected, check-in, pre-op, in surgery, recovery, admission, discharge, and home.

18. The computer-readable storage medium of claim 13, wherein the computer program instructions further comprise code for facilitating communication of one or more messages between the patient and the user associated with the patient, the one or more messages corresponding to a status update of the one or more status updates.

19. The computer-readable storage medium of claim 18, wherein the one or more messages indicate an emotion of the patient or the user associated with the patient.

20. The computer-readable storage medium of claim 13, wherein providing, to the second client device, the one or more status updates about the patient to the user associated with the patient comprises displaying the one or more status updates about the patient in a patient progress bar graphical user interface on the second client device.

21. The computer-readable storage medium of claim 13, wherein the computer program instructions further comprise code for:
generating one or more content items including information associated with the patient or the medical procedure; and
providing the generated one or more content items to the first client device for display to the patient.

22. The computer-readable storage medium of claim 21, wherein the computer program instructions further comprise code for providing the generated one or more content items to the second client device for display to the user associated with the patient.

23. The computer-readable storage medium of claim 21, wherein the generated one or more content items indicate a transaction of a gift purchased for or purchasable for the patient by the user associated with the patient.

24. The computer-readable storage medium of claim 21, wherein the generated one or more content items are based at least in part on a medical recommendation from the healthcare provider and provide information about the medical recommendation from the healthcare provider.

25. The computer-readable storage medium of claim 13, wherein the computer program instructions implement a technical safeguard for compliance with the Health Insurance Portability and Accountability Act (HIPAA).
